(19) United States
(12) Patent Application Publication
(10) Pub. No.: US 2024/0330973 A1
(43) Pub. Date: Oct. 3, 2024

(54) CUSTOMER LOYALTY REWARDS SYSTEM

(71) Applicant: 5321 Innovation Labs LLC, Franklin, MA (US)

(72) Inventors: Tyler Nesper, Denver, CO (US); Edward Neipris, Wrentham, MA (US)

(21) Appl. No.: 18/616,428

(22) Filed: Mar. 26, 2024

Related U.S. Application Data
(60) Provisional application No. 63/456,016, filed on Mar. 31, 2023.

(51) Int. Cl. G06Q 30/0226

(52) U.S. Cl. CPC G06Q 30/0233

(57) ABSTRACT

A computer system for issuing customer loyalty rewards includes a rewards regulator in electronic communication with a plurality of communication service providers (CSPs), which supply network connectivity and related services to a group of customers. The rewards regulator includes a rules engine for establishing and maintaining a set of rules for issuing customer loyalty rewards based on defined parameters of customer data use. The rewards regulator additionally includes a rewards engine configured to electronically receive customer data use information from the plurality of communication providers, compare the customer data use information against the set of rules maintained by the rules engine and, when applicable, establish customer loyalty rewards to be issued in compliance with the set of rules. At least one rewards organization in electronic communication with the rewards regulator is configured to receive and process customer loyalty rewards determined by the rewards engine.

### CROSS-REFERENCE TO RELATED APPLICATIONS

The present invention claims the benefit under 35 U.S.C. 119 (e) to U.S. Provisional Patent Application No. 63/456,016, which was filed on Mar. 31, 2023, in the names of Tyler Nesper et al., the disclosure of which is incorporated herein by reference.

### FIELD OF THE INVENTION

The present invention relates generally to the field of telecommunications and, more particularly, to communication service providers that supply customers with wireless network connectivity and other related services.

### BACKGROUND OF THE INVENTION

Mobile devices, such as smartphones, smartwatches, and tablet computers, are routinely utilized to perform a wide array of daily functions including, but not limited to, voice and video calling, internet browsing, video streaming, and gaming. To engage in such activities, mobile devices often rely upon the telecommunication network infrastructure and services offered by established communication service providers (CSPs). To accommodate the exponential increase in the use of mobile devices, CSPs are continuously expanding and enhancing their wireless technology to allow for the transmission of greater amounts of data at increasingly faster speeds.

Communication service providers typically regulate consumer access to network services by requiring a subscription to a data plan. Traditionally, a CSP data plan stipulates, most often on a monthly basis, the amount data that can be transmitted by a customer through the network for a designated fee. If the customer exceeds the data limit for a specified period, additional charges may accrue.

Customers generally want to optimize their data plans in order maximize the use of the network services. At the same time, data plan subscriptions that offer the greatest amount of data usage (e.g., unlimited data plans) typically carry a premium cost. For this reason, CSP customers are routinely conflicted between maximizing data use and minimizing network access costs.

By comparison, CSPs most often seek to encourage customer data use in order to drive revenues. However, because increased usage requires a commensurate increase in both available resources and network bandwidth, CSPs value customers that utilize a substantially lower amount of data than contractually afforded, since the limited data use benefits the overall network throughput.

Traditionally, CSPs engage in various forms of media marketing (e.g., television marketing, radio marketing, and social media marketing) to create brand recognition and promote available data plan offerings. However, most conventional CSP promotional efforts are directed to the general consuming public and rarely target current customers to show appreciation for their loyalty and repeat business.

### SUMMARY OF THE INVENTION

In view thereof, it is an object of the present invention to provide a novel system for issuing loyalty rewards to customers of communication service providers (CSPs).

It is another object of the present invention to provide a system of the type as described above which is configured to issue loyalty rewards based on a set of rules relating to customer data usage.

It is yet another object of the present invention to provide a system of the type as described above wherein the set of rules which defines the parameters for the issuance of loyalty rewards is modifiable.

It is still another object of the present invention to provide a system of the type as described above which is configured to operate in a largely automated fashion.

It is yet still another object of the present invention to provide a system of the type as described above which is easy to implement, incurs limited operational costs, and is readily scalable.

Accordingly, as one feature of the present invention, there is provided a system for issuing customer loyalty rewards, the system comprising (a) a plurality of communication service providers, each communication service provider including an external computer network that compiles customer data use information, and (b) a rewards regulator in electronic communication with the external computer network for each of the plurality of communication service providers, the rewards regulator comprising (i) a rules engine for establishing and maintaining a set of rules for issuing customer loyalty rewards based on defined parameters of customer data use, and (ii) a rewards engine configured to electronically receive customer data use information from the plurality of communication providers, compare the customer data use information against the set of rules maintained by the rules engine and, when applicable, establish customer loyalty rewards to be issued in compliance with the set of rules.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified system diagram of a customer loyalty rewards system designed according to the teachings of the present invention; and

FIG. 2 is a flow chart depicting a novel process for issuing usage-based loyalty rewards to customers of communication service providers using the system of FIG. 1.

### DETAILED DESCRIPTION OF THE INVENTION

### Customer Loyalty Rewards System 11

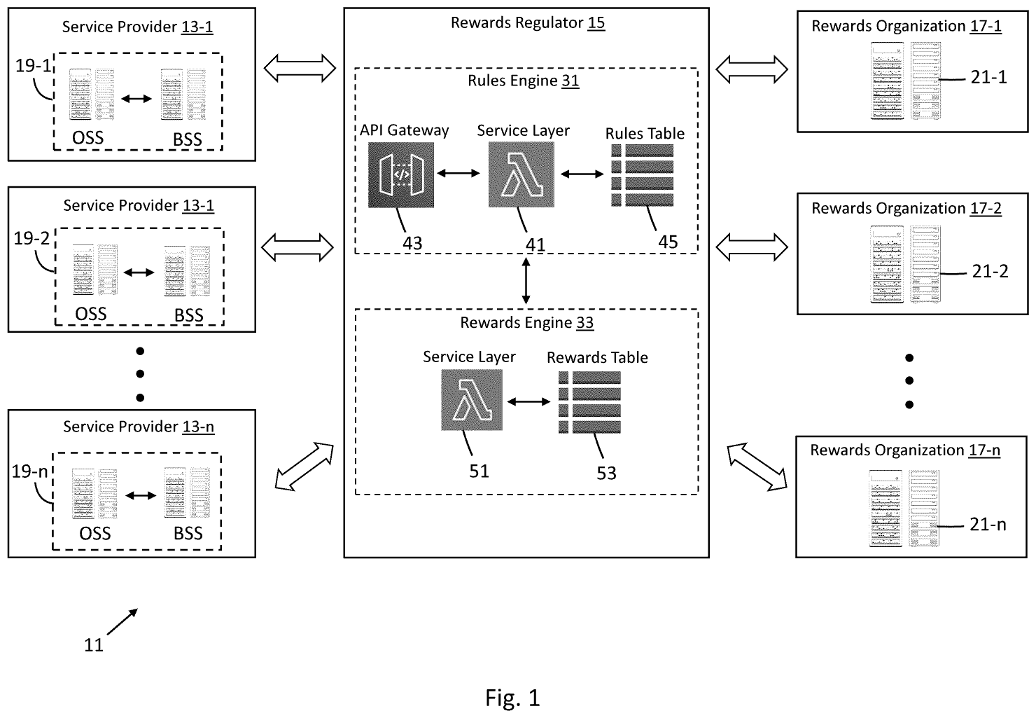

Referring now to FIG. 1, there is shown the basic architecture of a customer loyalty rewards system designed according to the teachings of the present invention, the rewards system being identified generally by reference numeral 11. As will be explained in detail below, system 11 is uniquely configured to issue loyalty rewards to customers of communication service providers (CSPs) based on defined rules and policies. In this manner, system 11 effectively promotes and incentivizes customers to utilize the various services offered by the CSPs, thereby stimulating future business growth.

As will be described in detail below, computer system 11 relies primarily upon customer data usage to determine loyalty rewards. As defined herein, use of the term “data usage” or “data use” denotes any measurable form of consumer use of services offered by communication service providers. Examples of measurable forms of data use include, inter alia, internet data (i.e., mobile data required to transfer data over the internet), short message service (SMS) data (i.e., text messaging data), voice data (i.e., telephone-based data, or talk time), and the like.

Although the present invention is directed primarily to the issuance of loyalty rewards based on customer data usage (e.g., in relation to a set data plan), it should be noted that system 11 could be additionally configured to issue loyalty rewards based on the underlying customer data plan (e.g., the particular data plan selected or the active duration of service).

As can be seen, customer loyalty rewards system 11 comprises (i) a plurality of communication service providers, or service providers, 13-1 thru 13-n that provide, inter alia, network connectivity and services to various customers, (ii) a rewards regulator 15 in electronic communication with each of the CSPs 13 for monitoring consumer use of services offered by CSPs 13 and, in turn, establishing rewards tor customers that reach certain predefined, usage-based parameters, and (iii) a plurality of rewards organizations 17-1 thru 17-n in electronic communication with rewards regulator 15 for processing (i.e., issuing) the various loyalty rewards determined by rewards regulator 15.

Each communication service provider, or service provider, 13 represents any entity that provides communication and information-based services to a wide variety of customers using wireless communication technologies, such as cellular and Wi-Fi networks. Most commonly, individual customers obtain access to the network services provided by CSPs 13 by subscribing to a particular data plan.

Traditionally, a CSP data plan stipulates, typically on a monthly basis, the amount of data that can be transmitted by the customer through the network for a designated fee. If the customer exceeds the data limit for a specified period, additional charges may accrue. As a result, customers are often conflicted between maximizing data use and minimizing access costs. The present invention attempts to optimize data use trends by establishing customer loyalty rewards if the measured data use reaches certain predefined thresholds.

Each service provider 13 includes an external computer system, or network, 19 which, inter alia, collects and maintains data use information for each customer. The data use information maintained by external system 19 includes, but is not limited to, monthly data usage, data plan subscription type, and data plan subscription length.

As can be seen, external system 19 is generally in the form of a computer network that is appropriately designed to accumulate the requisite data use information for each subscribed customer. For instance, as shown herein, external system 19 may include both (i) an operation support system (OSS), which is a backend information technology infrastructure that enables CSPs to create, organize, maintain, and manage network services, and (ii) a business support system (BSS), which is software solution that enables CSPs to manage and streamline frontend (i.e., customer-facing) activities.

It should be noted that computer system 11 is not limited to any particular type and/or number of service providers 13. In fact, due to the scalable nature of system 11, additional service providers 13 could be readily integrated into system 11 by simply establishing a direct communication path with loyalty rewards regulator 15.

As referenced briefly above, rewards regulator 15 serves as the central hub between the plurality of service providers 13 and the plurality of rewards organizations 17. As will be explained further in detail below, rewards regulator 15 is designed to (i) maintain of a list of rules that stipulate loyalty rewards to be granted based on certain parameters of customer data usage, and (ii) apply these rules against compiled data use records to establish customer rewards to be processed by rewards organizations 17.

As can be appreciated, the integration, design, and operation of loyalty rewards regulator 15 within a telecommunications environment is considered novel and introduces a number of previously unforeseen advantages over prior art systems. Accordingly, it is to be understood that the configuration and functionality of rewards regulator 15 serve as primary novel features of the present invention and will be explained in greater detail below.

Rewards organizations 17 are configured to (i) receive electronic rewards instructions, or requests, from regulator 15 and, in turn, (ii) electronically issue, or grant, specified loyalty rewards to customers in compliance with the rewards instructions. Preferably, each rewards organization 17 includes a compute device, or controller, 21 to automate the two-step process of receiving a reward request and, in turn, releasing an electronic loyalty reward to the customer.

It is to be understood that the electronic issuance of loyalty rewards can be sent either (i) directly to the customer (e.g., by text message), (ii) to the appropriate customer account maintained by CSP 13 (e.g., as future credit to be applied against the active data plan), or (iii) to an affiliated third-party business (not shown) that is contracted by service provider 13 and/or organization 17 to grant selected benefits (e.g., an electronic gift card) to the customer.

In the present embodiment, each rewards organization 17 is represented as a separate (i.e., outsourced) entity that is solely responsible for the management and issuance of loyalty rewards. However, it is to be understood that organization 17 could be effectively eliminated by incorporating the rewards management and issuance processes directly into the architecture of rewards regulator 15.

### Rewards Regulator 15

As referenced above, rewards regulator 15 serves as a central controller, or hub, between the plurality of service providers 13 and the plurality of rewards organizations 17. As will be explained further below, rewards regulator 15 is responsible for monitoring customer data usage and, in turn, establishing loyalty rewards when the measured usage of CSP services reaches certain defined parameters.

As seen in FIG. 1, rewards regulator 15 comprises (i) a rules engine 31 for establishing and maintaining rules for issuing customer loyalty rewards and (ii) a rewards engine 31 that compiles customer data use records from a selection of service providers 13, compares the data use records against the rewards rules applicable to that customer and, when applicable, transmits loyalty rewards instructions, or requests, to organizers 17 to electronically create and release certain loyalty rewards to the appropriate customer accounts.

In the description that follows, rewards regulator 15 is shown implemented using an Amazon Web Services (AWS) cloud computing services platform, thereby allowing for an optimized selection and configuration of web services tools. However, is should be known that the use of an AWS-based cloud computing services platform is provided for illustrative purposes only and rules regulator 15 could be similarly implemented using alternative cloud computing services platforms, such as the Microsoft Azure cloud computing services platform, without departing from the spirit of the present invention.

As can be seen, rules engine 31 comprises a service layer processing service, or service layer, 41 which is configured to maintain a dynamic list of rules that stipulate loyalty rewards to be granted based on certain parameters of customer data usage. For illustrative purposes only, service layer 41 is represented herein as being implemented using the AWS Lambda processing service.

As noted above, service layer 41 is designed to perform the custom, user-specified task of maintaining a modifiable list of royalty rewards rules. User access to service layer 41 (i.e., to add, remove, and/or modify rewards rules) is preferably obtained by authenticated individuals through an application programming interface (API) user gateway 45 which is connected to the internet. Accordingly, authorized users are able to access service layer 41 and, in turn, create, delete, and/or edit a set of loyalty rules that is maintained in a rules table 45.

It is to be understood that the customer loyalty rewards rules maintained by rules engine 31 are designed to be modifiable, with the parameters customized to optimize the marketing objectives of each service provider 13. For example, one rewards rule may stipulate that customers that exceed a certain monthly data use threshold (e.g., over 200 GB of monthly mobile data) receive a credit (e.g., $10) towards a future billing cycle as appreciation for the customer business. Another rewards rule my stipulate that customers that use a limited amount of data use for a particular period (e.g., less than 20% of the permitted monthly data use) receive, for example, a future promotion (e.g., a 10% renewal discount) or an amount of loyalty points credited to a user account as appreciation for minimizing the customer impact on the overall network throughput, thereby freeing available resources for other customers.

As noted briefly above, rewards regulator 15 additionally includes a rewards engine 31 that compiles customer data use records from a selection of service providers 13, compares data use records against the rewards rules applicable to that customer and, when applicable, transmits loyalty rewards instructions, or requests, to organizers 17 to electronically create and release certain loyalty rewards to the appropriate customer accounts.

Rewards engine 31 is shown comprising a service layer processing service, or service layer, 51 which is configured to directly communicate with service providers 13 and electronically compile customer data use records. In turn, service layer 51 compares the compiled customer data use records against the rewards rules maintained in rules table 45. If service layer 51 determines that certain rewards parameters have been reached, the details of such rewards (e.g., customer information, reward type, reward amount, etc.) are logged in a rewards table 53 and, in turn, transmitted to the appropriate rewards organization 17 for processing.

In the present embodiment, service layer 51 is represented herein as being implemented using the AWS Lambda processing service. However, as referenced above, alternative cloud-based services could be similarly utilized in place thereof without departing from the spirit of the present invention.

### Automated Customer Loyalty Rewards Issuance Process 111

As referenced above, system 11 is uniquely designed to implement a novel automated process for issuing loyalty rewards to customers of communication service providers 13, the process being identified generally herein using reference numeral 111. As will be explained in detail below, process 111 retrieves and compares customer user data against a set of dynamic rules to determine when to issue loyalty rewards. As a result, method 111 helps promote and incentivize the use of services offered by CSPs 13, which is highly desirable.

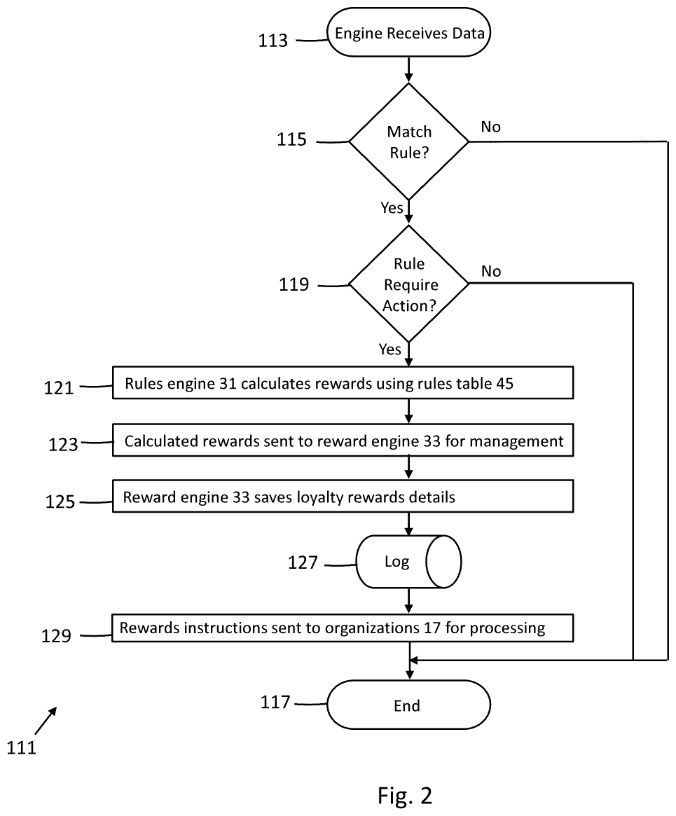

Referring now to FIG. 2, there is shown a simplified flow chart of loyalty rewards issuance process, or method, 111. As the first step of rewards issuance process 111, rewards engine 33 electronically receives customer data from service providers 13, this message receiving step being identified generally by reference numeral 113.

For example, as part of data receiving step 113, the operation support system (OSS) for an external system 19 verifies the amount of data used by a customer for a specified period and, in turn, compares the data use against a customer account maintained within its corresponding business support system (BSS). The data is then transmitted to rewards engine 33 to determine if certain loyalty rewards conditions have been met.

Rewards engine 33 parses the customer usage data and compares key data points against the defined rewards rules, or policies, stored within dynamic rules engine 31 to determine if the parameters of any maintained rules have been reached, or matched, this matching step being identified generally by reference numeral 115. If no rewards rules have been matched, method 111 terminates, as presented by end step 117.

However, if certain rewards rules have been matched, rules engine 31 determines if the matched rules require further action (i.e., the issuance of loyalty rewards), this action determination step being identified generally by reference numeral 119. If no further action is required (e.g., if the customer has already received the maximum number of allowable rewards or if a rewards promotion has been temporarily suspended), method 111 skips to end step 117.

Conversely, if further action is required, rules engine 31 calculates the specific loyalty rewards to issue using the defined rules and policies set forth in rules table 45, the rewards calculation step being identified generally by reference numeral 121. Thereafter, as a part of step 123, rules engine 31 sends the calculated rewards to rewards engine 33 for management. In turn, rewards engine 33 saves the rewards details as part of a rewards saving step 125. Subsequently, in step 127, the rewards values are logged in rewards table 53.

Having determined the specifics of the loyalty rewards to issue, rewards engine 33 transmits rewards instructions to the appropriate rewards organizations 17 via standard communication protocols, the instruction transmission step being represented as step 129. In response, rewards organizations 19 handle the management of the requisite rewards to be issued, or granted, to customers. As can be appreciated, the loyalty reward may be in any standard form, such as redeemable points, discounts, cashback, or the like.

Upon completion of instruction step 129, method 111 advances to end step 117. However, it is to be understood that, under ideal conditions, rewards issuance process 111 repeats, as needed (e.g., at defined intervals). In this manner, as new data use information is obtained by CSPs 13, rewards regulator 15 is able to identify and process new loyalty rewards.

As an illustrative example of method 111, rewards engine 33 may query the OSS of an external system 19 of a CSP 13 in order to obtain the amount of data, voice, or text services utilized by a customer. In response, as part of step 113, the OSS provides the usage information to rewards engine 33, which, in turn, compares the data use against customer account information stored within the BSS.

Thereafter, rewards engine 33 provides the data to dynamic rules engine 31. As part of step 115, dynamic rules engine 31 compares the usage data against stored rewards rules to identify if there is a match. For instance, one rule may stipulate that if a customer uses 20% less data than the purchased allowable amount, a match condition is triggered. If an action is required in response, as determined in step 119, the dynamic rules engine 31 could perform the necessary calculations based on the stored rules, as part of step 121. The calculated reward (e.g., 100 points credited to a customer loyalty account) is then sent to reward engine 33 in step 123. In response, reward engine 33 saves and logs the loyalty rewards details, as part of steps 125 and 127. Finally, in step 129, reward engine 33 instructs a reward organization 17 to electronically issue the calculated reward (e.g., 100 points) to the appropriate customer account.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for issuing customer loyalty rewards, the system comprising:
(a) a plurality of communication service providers, each communication service provider including an external computer network that compiles customer data use information; and
(b) a rewards regulator in electronic communication with the external computer network for each of the plurality of communication service providers, the rewards regulator comprising,
(i) a rules engine for establishing and maintaining a set of rules for issuing customer loyalty rewards based on defined parameters of customer data use, and
(ii) a rewards engine configured to electronically receive customer data use information from the plurality of communication providers, compare the customer data use information against the set of rules maintained by the rules engine and, when applicable, establish customer loyalty rewards to be issued in compliance with the set of rules.

2. The system as claimed in claim 1 wherein the set of rules maintained by the rules engine is modifiable.

3. The system as claimed in claim 2 wherein the set of rules maintained by the rules engine includes rewards based on amounts of customer data used in relation to a defined threshold.

4. The system as claimed in claim 3 wherein the set of rules maintained by the rules engine is accessible and modifiable through an application programming interface (API) user gateway.

5. The system as claimed in claim 2 further comprising at least one rewards organization in electronic communication with the rewards regulator.

6. The system as claimed in claim 5 wherein the at least one rewards organization is configured to receive and process loyalty rewards requests sent from the rewards regulator.

7. The system as claimed in claim 6 wherein the at least one rewards organization electronically transmits customer loyalty rewards to appropriate customer accounts.

8. The system as claimed in claim 2 wherein the external computer network for each communication service provider includes an operation support system (OSS) and a business support system (BSS).
